(19) United States
(12) Patent Application Publication
(10) Pub. No.: US 2020/0363923 A1
(43) Pub. Date: Nov. 19, 2020

(54) METHOD FOR TRANSMITTING GRAPHICAL USER INTERFACE DETERMINED BASED ON VEHICLE IDENTIFICATION INFORMATION TO VEHICLE, AND ELECTRONIC DEVICE SUPPORTING SAME

(71) Applicant: Samsung Electronics Co., Ltd., Gyeonggi-do (KR)

(72) Inventors: Wonchang LEE, Gyeonggi-do (KR); Soungkwan KIMN, Gyeonggi-do (KR)

(21) Appl. No.: 16/962,286

(22) PCT Filed: Jan. 30, 2019
(86) PCT No.: PCT/KR2019/001267

§ 371 Date: Jul. 15, 2020

(30) Foreign Application Priority Data
Feb. 6, 2018 (KR) 10-2018-0014470

(51) Int. Cl. G06F 3/0484

(52) U.S. Cl. CPC G06F 3/0484; H04L 67/12

(57) ABSTRACT

Disclosed is an electronic device including at least one communication interface, a memory, and a processor electrically connected with the at least one communication interface and the memory, in which the processor is configured to detect connection with a vehicle by using the at least one communication interface, receive vehicle identification information from the vehicle, receive display format information of the vehicle corresponding to the vehicle identification information from an external server by using the at least one communication interface, determine a graphical user interface to be output through a display of the vehicle, based at least partly on the display format information, and transmit data related to the determined graphical user interface to the vehicle by using the at least one communication interface. Besides, it may be permissible to prepare various other embodiments speculated through the specification.

### TECHNICAL FIELD

Various embodiments of the disclosure described herein relate to a technology for operating a connected car service of an electronic device.

### BACKGROUND ART

With the widespread use of electronic devices equipped with independent operating systems, the electronic devices provide various functions or services for user convenience or interactions with users. For example, an electronic device may provide a connected car service through which the electronic device is connected to and interacts with a vehicle based on wired or wireless communication.

### DISCLOSURE

### Technical Problem

The connected car service may allow a graphical user interface related to operation of a function embedded in the electronic device or operation of infotainment contents included in the electronic device to be output by a display device in a vehicle. At this time, the graphical user interface to be output through the display device of the vehicle may not be suitable for a display format (or, a graphical element) that is specified for the vehicle. In this case, the graphical user interface on the electronic device may be output on the display device of the vehicle in a simple screen mirroring form, or may be output in a form in which user convenience (e.g., visibility, readability, or the like) is not considered.

Various embodiments of the disclosure described herein provide a method for transmitting a graphical user interface determined based on vehicle identification information to a vehicle, and an electronic device for supporting the same, in which when the electronic device is connected to the vehicle, the format of the graphical user interface to be output through the vehicle is transmitted after adjusted to correspond to characteristics of the vehicle (e.g., the format of a display of the vehicle).

### Technical Solution

An electronic device for supporting a connected car service according to an embodiment includes at least one communication interface that performs communication with at least one of a vehicle or an external server, a memory that stores at least one first application program, and a processor electrically connected with the at least one communication interface and the memory.

According to an embodiment, the processor detects connection with the vehicle by using the at least one communication interface, receives vehicle identification information from the vehicle, receives display format information of the vehicle corresponding to the vehicle identification information from the external server by using the at least one communication interface, determines a graphical user interface to be output through a display of the vehicle, based at least partly on the display format information, and transmits data related to the determined graphical user interface to the vehicle by using the at least one communication interface such that the determined graphical user interface is output through the display of the vehicle.

According to an embodiment, the processor detects connection with the vehicle by using the at least one communication interface, receives vehicle identification information from the vehicle, transmits the vehicle identification information to the external server by using the at least one communication interface, receives, from the external server, data related to a graphical user interface corresponding to the vehicle identification information and to be output through a display of the vehicle, and transmits, to the vehicle, the data related to the graphical user interface and received from the external server, by using the at least one communication interface such that the graphical user interface is output through the display of the vehicle.

A method for transmitting a graphical user interface determined based on vehicle identification information of an electronic device to a vehicle according to an embodiment includes detecting connection with the vehicle by using at least one communication interface, receiving the vehicle identification information from the vehicle, receiving display format information of the vehicle corresponding to the vehicle identification information from an external server by using the at least one communication interface, determining a graphical user interface to be output through a display of the vehicle, based at least partly on the display format information, and transmitting data related to the determined graphical user interface to the vehicle by using the at least one communication interface.

### Advantageous Effects

According to the various embodiments, a connected car service platform capable of outputting graphical user interfaces optimized for a plurality of different vehicles may be built.

In addition, the disclosure may provide various effects that are directly or indirectly recognized.

### DESCRIPTION OF DRAWINGS

FIG. 1 is a view illustrating one example of operation of an electronic device according to an embodiment.

FIG. 2 is a view illustrating a configuration of the electronic device according to an embodiment.

FIG. 3 is a view illustrating a signal flow between components related to operation of a connected car service according to an embodiment.

FIG. 4 is a view illustrating an exemplary form of a graphical user interface output on a vehicle display according to an embodiment.

FIG. 5 is a view illustrating a method for transmitting a graphical user interface of an electronic device to a vehicle according to an embodiment.

FIG. 6 is a view illustrating a method for transmitting a graphical user interface of an electronic device to a vehicle according to another embodiment.

FIG. 7 is a view illustrating an electronic device in a network environment according to an embodiment.

With regard to the description of the drawings, identical or similar reference numerals may be used to refer to identical or similar components.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure. With regard to description of drawings, similar components may be marked by similar reference numerals.

In the disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in the disclosure may be used to refer to various components regardless of the order and/or the priority and to distinguish the relevant components from other components, but do not limit the components. For example, “a first user device” and “a second user device” indicate different user devices regardless of the order or priority. For example, without departing the scope of the disclosure, a first component may be referred to as a second component, and similarly, a second component may be referred to as a first component.

It will be understood that when an component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when an component (e.g., a first component) is referred to as being “directly coupled with/to” or “directly connected to” another component (e.g., a second component), it should be understood that there are no intervening component (e.g., a third component).

According to the situation, the expression “configured to” used in the disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

An electronic device according to various embodiments of the disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit).

According to various embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automated teller machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of the disclosure may not be limited to the above-described electronic devices and may include other electronic devices and new electronic devices according to the development of technologies.

Hereinafter, electronic devices according to various embodiments will be described with reference to the accompanying drawings. In the disclosure, the term “user” may refer to a person who uses an electronic device or may refer to a device (e.g., an artificial intelligence electronic device) that uses the electronic device.

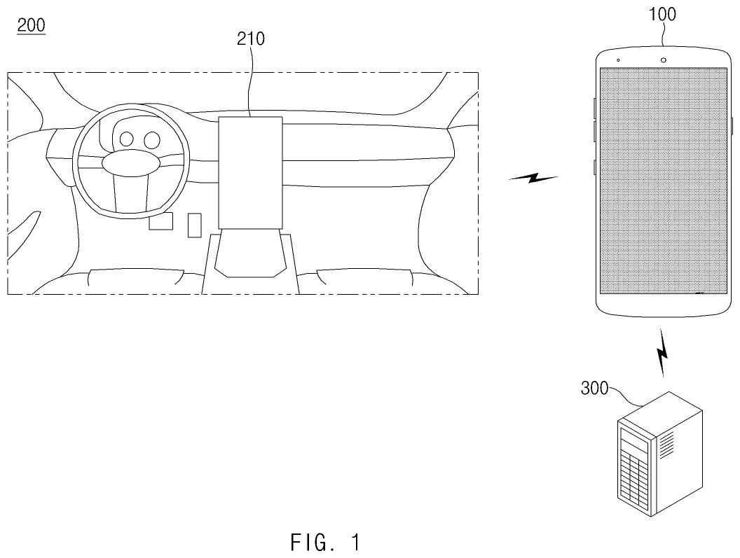

FIG. 1 is a view illustrating one example of operation of an electronic device according to an embodiment.

Referring to FIG. 1, based on wired or wireless connection with an adjacent vehicle 200, the electronic device 100 may operate a connected car service capable of being operated in conjunction with the vehicle 200. According to an embodiment, as a way to operate the connected car service, the electronic device 100 may output, through a display 210 in the connected vehicle 200, a graphical user interface related to operation of functions or contents included in the electronic device 100. In this regard, the electronic device 100 may interact with the vehicle 200 and a specified external server 300 to perform a series of processes for outputting the graphical user interface suitable for characteristics of the vehicle 200. For example, the electronic device 100 may connect to the related external server 300, based on vehicle identification information received from the connected vehicle 200 and may receive information about a display format (or, a graphical element) specified or optimized for the vehicle 200 from the external server 300. Based on the information received from the external server 300, the electronic device 100 may adjust or reconfigure the graphical user interface to be output through the display 210 of the vehicle 200. Accordingly, the vehicle 200 may receive data on the adjusted or reconfigured graphical user interface from the electronic device 100, may process the received data, and may output, on the display 210 of the vehicle 200, the graphical user interface related to the operation of the functions or the contents included in the electronic device 100.

Hereinafter, various embodiments related to output control of a graphical user interface suitable for characteristics of the vehicle 200 (e.g., the format or graphical element of the display 210) and functional operations of components for implementing the various embodiments will be described.

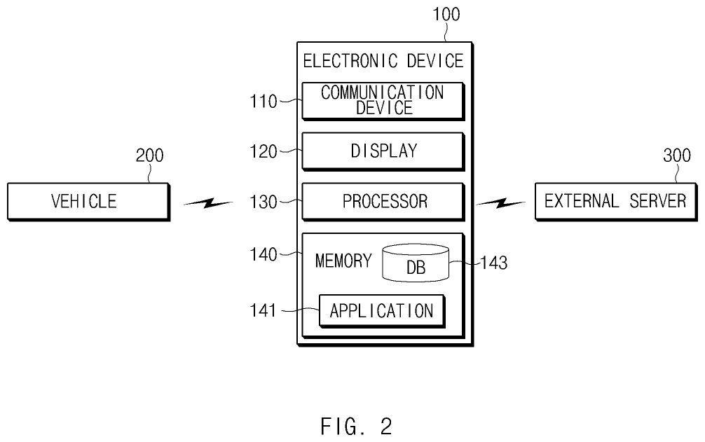

FIG. 2 is a view illustrating a configuration of the electronic device according to an embodiment.

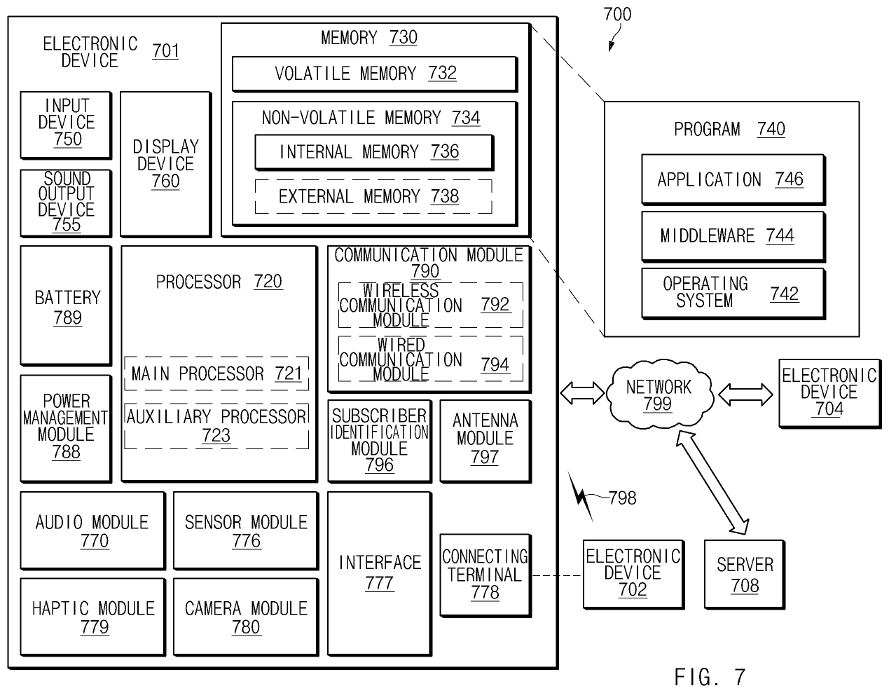

Referring to FIG. 2, the electronic device 100 may include a communication interface 110, a display 120, a processor 130, and a memory 140. According to various embodiments, the electronic device 100 may omit at least one of the aforementioned components, or may additionally include other component(s). For example, the electronic device 100 may further include a power supply device (e.g., a battery or the like) that supplies driving power to the components, a sensor device (e.g., a proximity sensor, an illuminance sensor, an acceleration sensor, a fingerprint recognition sensor, an iris recognition sensor, or the like) that senses various types of information about an operating environment of the electronic device 100, a camera device (e.g., a front camera, a rear camera, and/or the like) that takes an image (e.g., a still image, a video, or the like) of an area around the electronic device 100, or the like. Alternatively, the electronic device 100 may further include components of an electronic device 701 that will be mentioned below with reference to FIG. 7.

The communication interface 110 may support communication between the electronic device 100 and at least one external device (e.g., the vehicle 200 and/or the external server 300). For example, the communication interface 110 may transmit and receive data or signals related to operation of a connected car service, by establishing wired communication or wireless communication with the at least one external device according to a specified protocol and connecting to the at least one external device, based on the wired communication or the wireless communication. In this regard, the communication interface 110 may include a wired communication interface (e.g., a USB connector, a USB port, a USB cable, or the like) or a wireless communication interface (e.g., Wi-Fi direct, Bluetooth, or the like).

The display 120 may output various types of contents. For example, the display 120 may output a screen related to a function or an application program embedded in the electronic device 100, or may visually output data received from the at least one external device (e.g., the vehicle 200 and/or the external server 300). According to an embodiment, the display 120 may be switched to a black screen state at the time when output of a graphical user interface in the vehicle 200 is detected. For example, the display 120 may be switched to the black screen state when the electronic device 100 requests the vehicle 200 to output the graphical user interface with the transmission of data of the graphical user interface to the vehicle 200 and receives a notification (or, a response) for the output of the graphical user interface from the vehicle 200. This may be to reduce power consumption by controlling the electronic device 100 to a low-power state while the electronic device 100 is connected to the vehicle 200 because at least some functions of the electronic device 100 are operable through the vehicle 200, based on activation of the connected car service. Alternatively, this may be to suppress user operation of the electronic device 100, which acts as a factor detrimental to travel of the vehicle 200, while the electronic device 100 is connected to the vehicle 200. According to another embodiment, the display 120 may not be switched to the black screen state and may be controlled to a state of not receiving or processing a signal depending on a user input (e.g., a touch, a drag, hovering, or the like) within a specified period of time from the time when the electronic device 100 is connected to the vehicle 200.

The processor 130 may be electrically or operatively connected with at least one component of the electronic device 100 and may perform control, communication operations, or data processing for the component. According to an embodiment, the processor 130 may process connected-car-service-related data received from the at least one external device (e.g., the vehicle 200 and/or the external server 300), by controlling execution of a specific application program (e.g., a connected car service launcher application program to be described below). In other words, the processor 130 may control the specific application program to adjust or reconfigure the format of a graphical user interface, which is to be output on a display (e.g., 210 of FIG. 1) of the vehicle 200, by using the connected-car-service-related data received.

The memory 140 may store at least one piece of data involved in operation of functions of the electronic device 100, or may store instructions related to functional operations of the components of the electronic device 100. Alternatively, the memory 140 may store at least one application program 141. The at least one application program 141 may include, for example, a preloaded application program (e.g., watch, calendar, gallery, or the like) embedded at the time of manufacturing the electronic device 100. Alternatively, the at least one application program 141 may include a third-party application program installed through an online market such as the App Store. In an embodiment, the at least one application program 141 may include a connected car service launcher application program (hereinafter, referred to as the launcher application program) that is stored in the form of the preloaded or third-party application program and that supports operation of the connected car service of the electronic device 100. Under the control of the processor 130, the launcher application program may adjust or reconfigure the format of the graphical user interface, which is to be output on the display 210 of the vehicle 200 connected with the electronic device 100, depending on characteristics of the vehicle 200.

In an embodiment, in a case where the electronic device 100 is connected with a plurality of different vehicles 200 at different time, the memory 140 may build a database 143 by distinguishing between a plurality of pieces of vehicle identification information provided from the respective vehicles 200. Alternatively, in a case where the electronic device 100 is connected with the external server 300, the memory 140 may map and store format information of the display 210 of the vehicle 200 (or, graphical element information of the display 210) that is provided from the external server 300 and the corresponding vehicle identification information on the database 143.

In various embodiments, the memory 140 may include a secure area implemented in hardware or software. The secure area may be accessed based on a specified signal or route and may store, for example, security-authentication-related information (e.g., a user's biometric information or the like) that is involved when the electronic device 100 connects to the vehicle 200 or the external server 300.

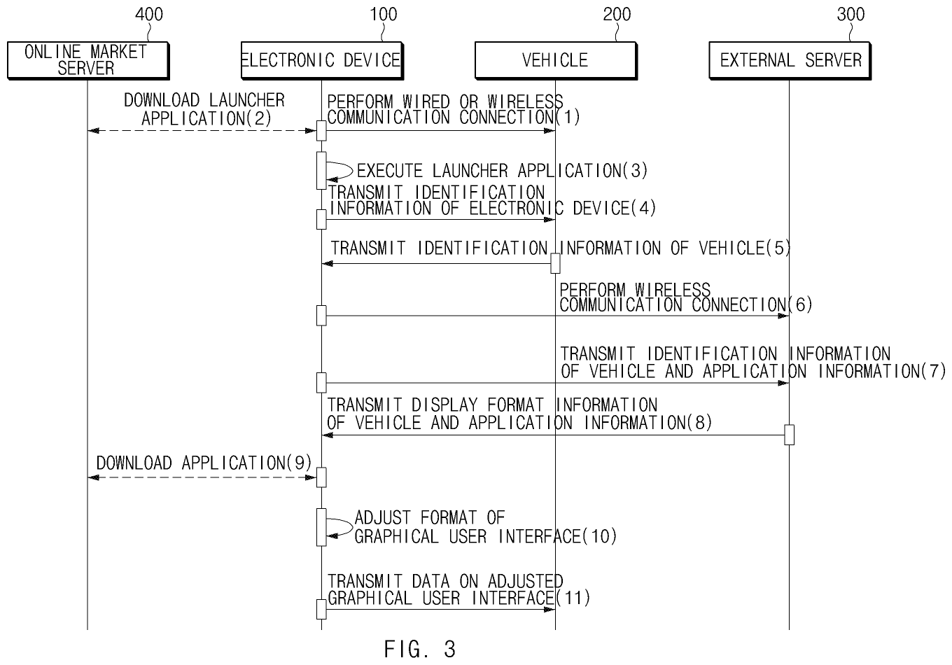

FIG. 3 is a view illustrating a signal flow between components related to operation of a connected car service according to an embodiment.

Referring to FIG. 3, in operation 1, the electronic device 100 may be connected with the vehicle 200, based on a wired communication interface (e.g., a USB connector, a USB port, a USB cable, or the like) or a wireless communication interface (e.g., Wi-Fi direct, Bluetooth, or the like). A processor (e.g., 130 of FIG. 2) of the electronic device 100 may detect the vehicle 200 connected through the wired communication interface or the wireless communication interface. In an embodiment, when the electronic device 100 is connected to the vehicle 200, it may mean that access or interaction between the processor 130 of the electronic device 100 and a vehicle system (e.g., an audio video navigation (AVN) system, an in-vehicle infotainment (IVI) system, or the like) mounted in the vehicle 200 is possible.

According to various embodiments, in a case where the electronic device 100 is connected to the vehicle 200 through the wireless communication interface, the processor 130 may search for a connectable external device (e.g., the vehicle 200) around the electronic device 100 and may output a list including at least one found external device on a display (e.g., 120 of FIG. 2). Based on a user input (e.g., a touch) for selecting one of the external devices included in the list, the processor 130 may perform wireless communication connection with an external device (e.g., the vehicle 200) selected by a user. According to various embodiments, when the electronic device 100 is connected with the vehicle 200, the electronic device 100 may receive a request for specified security authentication (e.g., user biometric-information authentication, specified code information authentication, or the like) from the vehicle system, may transmit an outcome of the security authentication to the vehicle system, and may be operatively connected to the vehicle 200 when approved.

In operation 2, when the connection between the electronic device 100 and the vehicle 200 is completed, the processor 130 of the electronic device 100 may determine whether the electronic device 100 includes a launcher application program. When it is determined that the launcher application program is not present on the electronic device 100, the processor 130 may download the launcher application program from a specified online market server 400. Alternatively, when it is determined that the launcher application program is not present on the electronic device 100, the processor 130 may generate a message to guide download of the launcher application program and may output the message through the display (e.g., 120 of FIG. 2).

In operation 3, the processor 130 of the electronic device 100 may execute the launcher application program in response to user control. Alternatively, the processor 130 may execute the launcher application program in response to scheduling information triggered within a specified period of time from when the electronic device 100 is connected to the vehicle 200. According to an embodiment, the launcher application program may operate under the control of the processor 130 to manage data involved in operation of a connected car service of the electronic device 100 and adjust or reconfigure the format of a graphical user interface to be output on a display (e.g., 210 of FIG. 1) of the vehicle 200, by using the data according to occurrence of a specified event (e.g., receipt of specific information from the external server 300 that will be described below).

In operations 4 and 5, the processor 130 of the electronic device 100 may transmit identification information (e.g., model information, operating system information, or the like) of the electronic device 100 to the connected vehicle 200 and may receive identification information (e.g., model information, operating system information, manufacturer information, or the like) of the vehicle 200 from the vehicle system. In an embodiment, the processor 130 may store the identification information of the vehicle 200, which is received from the vehicle system, in a database (e.g., the database 143 of FIG. 2) that is built in the electronic device 100.

In operation 6, the processor 130 of the electronic device 100 may determine the external server 300 related to the vehicle 200, based on the vehicle identification information. According to an embodiment, the external server 300 may include at least one of a server of a manufacturer of the vehicle 200 or a server of a manufacturer of an operating system of the vehicle 200. The processor 130 may be communicatively or operatively connected with the determined external server 300 by performing wireless communication (e.g., LTE communication or the like). Alternatively, the processor 130 may exclude determination of the external server 300 depending on the vehicle identification information and may be connected to the external server 300 having the form of an integrated server that manages the connected car service. According to various embodiments, the electronic device 100 (or, a user of the electronic device 100) may perform a log-in or sign-up procedure for the external server 200 in the operation of connecting with the external server 200.

In operation 7, the processor 130 of the electronic device 100 may transmit, to the connected external server 300, the vehicle identification information received from the vehicle system. Alternatively, the processor 130 may transmit, to the connected external server 300, information (e.g., an application program identifier, application program version information, or the like) regarding at least one application program (e.g., 141 of FIG. 2) (hereinafter, referred to as the first application program) that the electronic device 100 includes.

In operation 8, in response to the receipt of the information (e.g., the receipt of the vehicle identification information) from the electronic device 100, the external server 300 may transmit, to the electronic device 100, data on format information of the display 210 (or, graphical element information of the display 210) (e.g., layout information, color information, resolution information, image design information, or the like) that is specified for the vehicle 200, to which the electronic device 100 is connected, or suitable for characteristics of the vehicle 200. In an embodiment, in a case where the external server 300 is implemented with a server (e.g., an integrated server that manages the connected car service) that has no direct relation with the vehicle 200, the external server 300 may include format information of the display 210 that corresponds to at least one vehicle 200. Accordingly, the external server 300 may determine the vehicle 200 connected with the electronic device 100, based on the vehicle identification information received from the electronic device 100, may select data on format information of the display 210 (or, graphical element information of the display 210) that corresponds to the determined vehicle 200, and may transmit the selected data to the electronic device 100.

Furthermore, the external server 300 may include information about an application program operable in the at least one vehicle 200, and similarly to that described above, based on the vehicle identification information received from the electronic device 100, the external server 300 may transmit, to the electronic device 100, information about an application program (e.g., an application program related to a telephone call, a message, navigation, music, adjustment of the temperature of the vehicle 200, or the like) (hereinafter, referred to as the second application program) that is operable in the corresponding vehicle 200. The application program operable in the vehicle 200 may be specified by, for example, a manufacturer of the electronic device 100, a manufacturer of the vehicle 200, or a specified institution and may include an application program that does not act as a factor detrimental to travel of the vehicle 200 or in which contents (e.g., a font, an icon, or the like) output according to execution of the application program have readability or visibility higher than or equal to a specified level.

According to various embodiments, the external server 300 may determine whether the second application program is included in the first application program information received from the electronic device 100. In a case where at least part of the second application program is included in the first application program information, the external server 300 may additionally determine whether the versions of the corresponding application programs are in agreement with each other and may transmit feedback information regarding an outcome of the determination to the electronic device 100.

In operation 9, based on the second application program information received from the external server 300, the processor 130 of the electronic device 100 may identify an application program that is not present on the electronic device 100. In this case, the processor 130 may access the online market server 400 and may download the identified application program. Alternatively, in various embodiments, the processor 130 may exclude download of the identified application program and may generate an image object (e.g., an icon) for the identified application program, and the use of the image object will be described below. In another case, depending on the feedback information received from the external server 300, the processor 130 may perform a version update on at least a part of the first application program that is included in the electronic device 100 and that corresponds to the second application program operable in the vehicle 200.

In various embodiments, the processor 130 may map and store the data on the format information of the display 210 of the vehicle 200 (or, the graphical element information of the display 210) and/or the information about the second application program that is received from the external server 300 and the corresponding vehicle identification information on the database 143.

In operation 10, the processor 130 of the electronic device 100 may transfer, to the launcher application program, the data (e.g., the format information of the display 210 of the vehicle 200 or the graphical element information of the display 210 of the vehicle 200) that is received from the external server 300. Under the control of the processor 130, the launcher application program may adjust or reconfigure the format of a graphical user interface to be output through the display 210 of the vehicle 200, by using at least part of the transferred data. In various embodiments, the adjusted or reconfigured graphical user interface may include an execution screen of the launcher application program that displays at least one image object (e.g., icon) related to execution of the second application program. Alternatively, the adjusted or reconfigured graphical user interface may include an execution screen or a pop-up window of the second application program that is output in response to a user input (e.g., a touch) for the at least one image object. In an embodiment, the processor 130 may map and store the data of the graphical user interface adjusted or reconfigured by the launcher application program and the corresponding vehicle identification information on the database 143.

In operation 11, the processor 130 of the electronic device 100 may transmit the data related to the adjusted or reconfigured graphical user interface to the vehicle system of the connected vehicle 200. Accordingly, the vehicle system may output the graphical user interface on the display 210 in the vehicle 200 by processing the data and may support operation of a related function of the electronic device 100, or may output a related screen or contents, depending on a user input (e.g., a touch) applied to the display 210. In an embodiment, the processor 130 may control the display 120 of the electronic device 100 to a black screen state at the time when the display 210 of the vehicle 200 outputs the graphical user interface. For example, the processor 130 may control the display 120 to the black screen state at the time of receiving a notification for the output of the graphical user interface from the vehicle system of the vehicle 200, thereby reducing power consumption of the electronic device 100.

According to various embodiments, in the case of receiving the data on the format information of the display 210 of the vehicle 200, to which the electronic device 100 is connected, from the external server 300 as in operation 8 described above, the processor 130 of the electronic device 100 may identify the database 143 built in the memory 140. For example, the processor 130 may determine a presence or absence of data received from the external server 300 by identifying the database 143, and in a case where the data is present, the processor 130 may exclude adjustment or reconfiguration of the graphical user interface through the launcher application program. In other words, in a case where there is a history in which data on the vehicle 200, to which the electronic device 100 is connected, is received from the external server 300, the processor 130 may obtain data of a graphical user interface corresponding to the connected vehicle 200 from the database 143 and may transmit the obtained data to the vehicle system.

In various embodiments, the online market server 400 and the external server 300 described above may be implemented with a single integrated server. In this case, the execution of the functions of the online market server 400 and the external server 300 described above may be understood as operations by the integrated server. For example, the integrated server may provide, to the electronic device 100, the data on the format information of the display 210 of the vehicle 200, to which the electronic device 100 is connected, and/or the information about the application program operable in the vehicle 200. Alternatively, the integrated server may support downloading, onto the electronic device 100, the launcher application program and/or the application program operable in the vehicle 200.

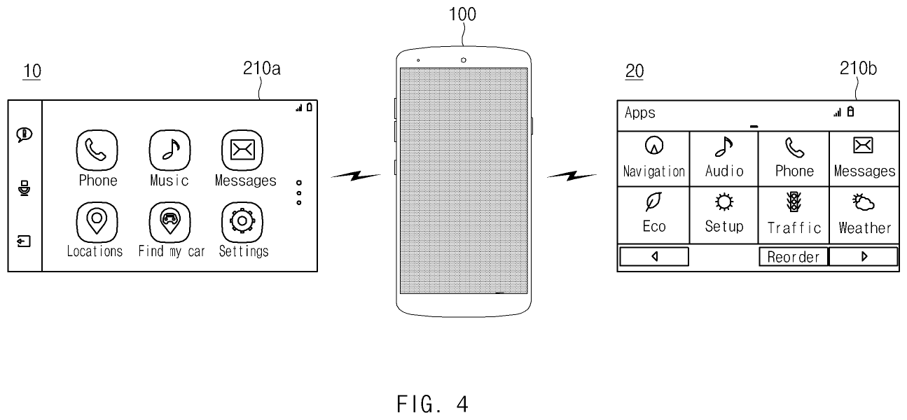

FIG. 4 is a view illustrating an exemplary form of a graphical user interface output on a vehicle display according to an embodiment.

Referring to FIG. 4, a first vehicle 10 to which the electronic device 100 is connected may process data of an adjusted or reconfigured graphical user interface received from the electronic device 100 and may output, on a display 210a, a graphical user interface that is suitable or optimized for characteristics of the first vehicle 10 (e.g., the format of the display 210a, the graphical element of the display 210a, or the like).

Correspondingly, in a case where the electronic device 100 is disconnected from the first vehicle 10 and is connected to a second vehicle 20 having different characteristics from the first vehicle 10, a graphical user interface suitable or optimized for characteristics of the second vehicle 20 may be output on a display 210b of the second vehicle 20. According to this, the format (or, the graphical element) of the graphical user interface output on the display 210b of the second vehicle 20 may at least partially differ from the format (or, the graphical element) of the graphical user interface output on the display 210a of the first vehicle 10.

In an embodiment, the graphical user interface output on the display 210b of the second vehicle 20 may include an image object (e.g., icon) at least partially different from the graphical user interface output on the display 210a of the first vehicle 10. This may mean that a function or an application program of the electronic device 100 that is operable through the second vehicle 20 at least partially differs from that of the first vehicle 10.

In an embodiment, in a case where the electronic device 100 is connected with the first vehicle 10 again after the disconnection from the first vehicle 10, the electronic device 100 may use data of a graphical user interface depending on the first vehicle 10 that is stored in a database (e.g., 143 of FIG. 2), without separate adjustment or reconfiguration of a graphical user interface to be output through the display 210a of the first vehicle 10.

According to various embodiments, a user input (e.g., a touch) for an image object (e.g., an icon) displayed on the above-described graphical user interface may be associated with download of an application program related to the corresponding image object. In this regard, referring to that described above, a processor (e.g., 130 of FIG. 2) of the electronic device 100 may receive, from an external device (e.g., 300 of FIG. 2), information about an application program operable through a vehicle to which the electronic device 100 is connected, and the processor may identify an absence of the corresponding application program on the electronic device 100. According to an embodiment, the processor 130 may download an identified application program, or may generate only an image object (e.g., an icon) for the identified application program without downloading the identified application program. The operation of excluding the download by the processor 130 may be performed to prevent unnecessary installation of an application program that is not executed through a vehicle, because application programs operated by users differ from one another. In a case where on the graphical user interface, a user input (e.g., a touch) is applied to an image object (e.g., an icon) of an application program that is not downloaded, the processor 130 may receive, from the vehicle, information about an application program related to the user input and may access an online market server (e.g., 400 of FIG. 2) to download the corresponding application program.

An electronic device for supporting a connected car service according to various embodiments may include at least one communication interface that performs communication with at least one of a vehicle or an external server, a memory that stores at least one first application program, and a processor electrically connected with the at least one communication interface and the memory.

According to various embodiments, the processor may detect connection with the vehicle by using the at least one communication interface, may receive vehicle identification information from the vehicle, may receive display format information of the vehicle corresponding to the vehicle identification information from the external server by using the at least one communication interface, may determine a graphical user interface to be output through a display of the vehicle, based at least partly on the display format information, and may transmit data related to the determined graphical user interface to the vehicle by using the at least one communication interface such that the determined graphical user interface is output through the display of the vehicle.

According to various embodiments, the electronic device may further include a display.

According to various embodiments, the processor may control the display to a black screen state, based at least partly on the connection with the vehicle.

According to various embodiments, the processor may determine the external server to be accessed, based at least partly on the vehicle identification information.

According to various embodiments, the processor may receive at least one of layout information, color information, resolution information, or image design information as at least part of an operation of receiving the display formant information of the vehicle from the external server.

According to various embodiments, the processor may additionally receive, from the external server, information about at least one second application program executable through the vehicle.

According to various embodiments, the processor may download, from a specified server, at least a part of the at least one second application program that is not included in the at least one first application program.

According to various embodiments, the processor may map and store the vehicle identification information and the display format information of the vehicle.

According to various embodiments, the processor may detect connection with the vehicle by using the at least one communication interface, may receive vehicle identification information from the vehicle, may transmit the vehicle identification information to the external server by using the at least one communication interface, may receive, from the external server, data corresponding to the vehicle identification information and related to a graphical user interface to be output through a display of the vehicle, and may transmit, to the vehicle, the data related to the graphical user interface and received from the external server, by using the at least one communication interface such that the graphical user interface is output through the display of the vehicle.

According to various embodiments, the processor may receive data on at least one graphical user interface in which at least one of a layout, a color, a resolution, or image design is set to correspond to the vehicle identification information, as at least part of an operation of receiving the data related to the graphical user interface from the external server.

According to various embodiments, the processor may map and store the vehicle identification information and the data related to the graphical user interface.

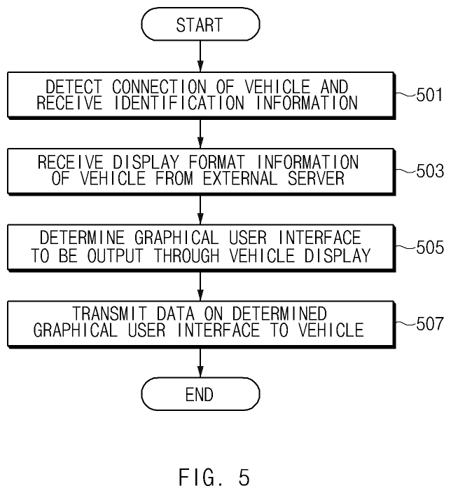

FIG. 5 is a view illustrating a method for transmitting a graphical user interface of an electronic device to a vehicle according to an embodiment. Operations to be described below with reference to FIG. 5 may at least partially correspond to, or may be at least partially similar to, those described above with reference to FIG. 3, and repetitive descriptions may be omitted.

Referring to FIG. 5, in operation 501, a processor (e.g., 130 of FIG. 2) of an electronic device (e.g., 100 of FIG. 2) may detect a vehicle (e.g., 200 of FIG. 2) that is connected based on a wired communication interface (e.g., a USB connector, a USB port, a USB cable, or the like) or a wireless communication interface (e.g., Wi-Fi direct, Bluetooth, or the like), and may receive identification information (e.g., model information, operating system information, manufacturer information, or the like) from the vehicle 200. According to various embodiments, when the connection of the vehicle 200 is detected, the processor 130 may determine whether the electronic device 100 includes a launcher application program. When it is determined that the electronic device 100 does not include the launcher application program, the processor 130 may access a specified online market server (e.g., 400 of FIG. 3) and may download the launcher application program.

In operation 503, the processor 130 of the electronic device 100 may receive, from an external server (e.g., 300 of FIG. 2), data on format information of a display (or, graphical element information of the display) of the vehicle 200 to which the electronic device 100 is connected. In this regard, the processor 130 may determine the related external server 300 (e.g., a server of a manufacturer of the vehicle 200, a server of a manufacturer of an operating system of the vehicle 200, or the like), based on the vehicle identification information received from the vehicle 200 and may perform wireless communication (e.g., LTE communication or the like) connection with the determined external server 300. The processor 130 may transmit the vehicle identification information to the connected external server 300 and may receive, from the external server 300, data on display format information (e.g., layout information, color information, resolution information, image design information, or the like) that corresponds to the vehicle identification information. Alternatively, the processor 130 may exclude determination of the external server 300 depending on the vehicle identification information and may receive display format information data corresponding to the vehicle identification information from the external server 300 having the form of an integrated server that manages a connected car service.

In operation 505, the processor 130 of the electronic device 100 may determine a graphical user interface to be output through a display (e.g., 210 of FIG. 1) of the connected vehicle 200. For example, the processor 130 may identify the display format information of the vehicle 200 received from the external server 300 and may control the launcher application program to adjust the graphical user interface, which is to be output on the display 210 of the vehicle 200, depending on characteristics of the vehicle 200 (e.g., the display format information, the graphical element information of the display, or the like) by using the data on the display format information.

In operation 507, the processor 130 of the electronic device 100 may transmit data on the determined graphical user interface (e.g., adjusted to correspond to the characteristics of the vehicle 200) to a system (e.g., an audio video navigation (AVN) system, an in-vehicle infotainment (IVI) system, or the like) in the connected vehicle 200. Accordingly, the vehicle 200 may process the data received from the electronic device 100 and may output, on the display 210 of the vehicle 200, the graphical user interface suitable or optimized for the characteristics of the vehicle 200. The processor 130 of the electronic device 100 may control the display 120 to a black screen state at the time of receiving a notification for the output of the graphical user interface from the vehicle 200, thereby reducing power consumption of the electronic device 100.

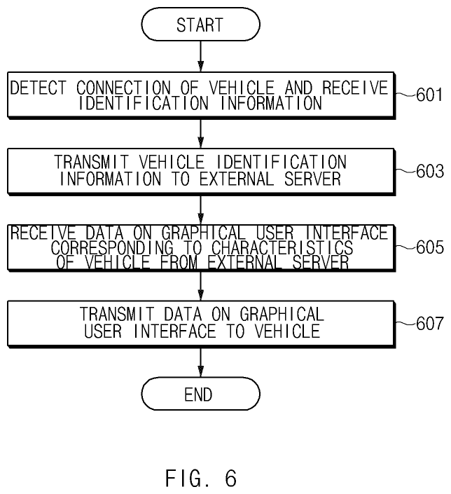

FIG. 6 is a view illustrating a method for transmitting a graphical user interface of an electronic device to a vehicle according to another embodiment.

Referring to FIG. 6, in operation 601, a processor (e.g., 130 of FIG. 2) of an electronic device (e.g., 100 of FIG. 2) may detect a vehicle (e.g., 200 of FIG. 2) that is connected based on a wired communication interface (e.g., a USB connector, a USB port, a USB cable, or the like) or a wireless communication interface (e.g., Wi-Fi direct, Bluetooth, or the like), and may receive identification information (e.g., model information, operating system information, manufacturer information, or the like) from the vehicle 200. In this operation, the processor 130 may determine whether the electronic device 100 includes a launcher application program, and when it is determined that the electronic device 100 does not include the launcher application program, the processor 130 may download the launcher application program from a specified online market server (e.g., 400 of FIG. 3).

In operation 603, the processor 130 of the electronic device 100 may connect to a related external server (e.g., 300 of FIG. 2) (e.g., a server of a manufacturer of the vehicle 200, a server of a manufacturer of an operating system of the vehicle 200, or the like), based on the vehicle identification information and may transmit the vehicle identification information to the external server 300.

In operation 605, the processor 130 of the electronic device 100 may receive, from the external server 300, data related to a graphical user interface to be output through a display (e.g., 210 of FIG. 1) of the vehicle 200. For example, the processor 130 may receive data that includes, in a package form, at least one graphical user interface having a layout, a color, a resolution, image design, or the like that is set (or, adjusted) so as to be suitable for characteristics of the vehicle 200 (e.g., the format of the display, the graphical element of the display, or the like). Accordingly, the processor 130 may exclude an operation of adjusting or reconfiguring the format of the graphical user interface, which is to be output through the display 210 of the vehicle 200, based on the launcher application program. In various embodiments, the processor 130 may map and store the graphical user interface data received from the external server 300 and the identification information of the connected vehicle 200 in a database (e.g., 143 of FIG. 2). Accordingly, the electronic device 100, when re-connected with the vehicle 200 later, may use the data of the graphical user interface that is stored in the database 143 and that corresponds to the vehicle 200.

In operation 607, the processor 130 of the electronic device 100 may transmit, to a system in the connected vehicle 200, the data received from the external server 300. The system of the vehicle 200 may process the data received from the electronic device 100 and may output the processed data on the display 210 of the vehicle 200. In an embodiment, the processor 130 may control the display 120 to a black screen state at the time of receiving a notification for the output of the graphical user interface from the vehicle 200.

A method for transmitting a graphical user interface determined based on vehicle identification information of an electronic device to a vehicle according to various embodiments may include detecting connection with the vehicle by using at least one communication interface, receiving the vehicle identification information from the vehicle, receiving display format information of the vehicle corresponding to the vehicle identification information from an external server by using the at least one communication interface, determining a graphical user interface to be output through a display of the vehicle, based at least partly on the display format information, and transmitting data related to the determined graphical user interface to the vehicle by using the at least one communication interface.

According to various embodiments, the method for transmitting the graphical user interface to the vehicle may further include controlling a display of the electronic device to a black screen state, based at least partly on the connection with the vehicle.

According to various embodiments, the receiving of the vehicle identification information include may include determining the external server to be accessed, based at least partly on the vehicle identification information.

According to various embodiments, the receiving of the display format information of the vehicle may include receiving at least one of layout information, color information, resolution information, or image design information.

According to various embodiments, the method for transmitting the graphical user interface to the vehicle may further include receiving, from the external server, information about at least one application program executable through the vehicle.

According to various embodiments, the receiving of the information about the at least one application program may include downloading, from a specified server, at least a part of the at least one application program that the electronic device does not include.

According to various embodiments, the receiving of the display format information of the vehicle may include mapping and storing the vehicle identification information and the display format information of the vehicle.

FIG. 7 is a view illustrating an electronic device in a network environment according to an embodiment.

Referring to FIG. 7, an electronic device 701 (e.g., the electronic device 100 of FIG. 1) may communicate with an electronic device 702 (e.g., the vehicle 200 of FIG. 1) through a first network 798 (e.g., a short-range wireless communication) or may communicate with an electronic device 704 or a server 708 (e.g., the external server 300 of FIG. 1) through a second network 799 (e.g., a long-distance wireless communication) in a network environment 700. According to an embodiment, the electronic device 701 may communicate with the electronic device 704 through the server 708. According to an embodiment, the electronic device 701 may include a processor 720 (e.g., the processor 130 of FIG. 2), a memory 730 (e.g., the memory 140 of FIG. 2), an input device 750, a sound output device 755, a display device 760 (e.g., the display 120 of FIG. 2), an audio module 770, a sensor module 776, an interface 777, a haptic module 779, a camera module 780, a power management module 788, a battery 789, a communication module 790 (e.g., the communication interface 110 of FIG. 2), a subscriber identification module 796, and an antenna module 797. According to some embodiments, at least one (e.g., the display device 760 or the camera module 780) among components of the electronic device 701 may be omitted or other components may be added to the electronic device 701. According to some embodiments, some components may be integrated and implemented as in the case of the sensor module 776 (e.g., a fingerprint sensor, an iris sensor, or an illuminance sensor) embedded in the display device 760 (e.g., a display).

The processor 720 may operate, for example, software (e.g., a program 740) to control at least one of other components (e.g., a hardware or software component) of the electronic device 701 connected to the processor 720 and may process and compute a variety of data. The processor 720 may load a command set or data, which is received from other components (e.g., the sensor module 776 or the communication module 790), into a volatile memory 732, may process the loaded command or data, and may store result data into a nonvolatile memory 734. According to an embodiment, the processor 720 may include a main processor 721 (e.g., a central processing unit or an application processor) and an auxiliary processor 723 (e.g., a graphic processing device, an image signal processor, a sensor hub processor, or a communication processor), which operates independently from the main processor 721, additionally or alternatively uses less power than the main processor 721, or is specified to a designated function. In this case, the auxiliary processor 723 may operate separately from the main processor 721 or embedded.

In this case, the auxiliary processor 723 may control, for example, at least some of functions or states associated with at least one component (e.g., the display device 760, the sensor module 776, or the communication module 790) among the components of the electronic device 701 instead of the main processor 721 while the main processor 721 is in an inactive (e.g., sleep) state or together with the main processor 721 while the main processor 721 is in an active (e.g., an application execution) state. According to an embodiment, the auxiliary processor 723 (e.g., the image signal processor or the communication processor) may be implemented as a part of another component (e.g., the camera module 780 or the communication module 790) that is functionally related to the auxiliary processor 723. The memory 730 may store a variety of data used by at least one component (e.g., the processor 720 or the sensor module 776) of the electronic device 701, for example, software (e.g., the program 740) and input data or output data with respect to commands associated with the software. The memory 730 may include the volatile memory 732 or the nonvolatile memory 734.

The program 740 may be stored in the memory 730 as software and may include, for example, an operating system 742, a middleware 744, or an application 746.

The input device 750 may be a device for receiving a command or data, which is used for a component (e.g., the processor 720) of the electronic device 701, from an outside (e.g., a user) of the electronic device 701 and may include, for example, a microphone, a mouse, or a keyboard.

The sound output device 755 may be a device for outputting a sound signal to the outside of the electronic device 701 and may include, for example, a speaker used for general purposes, such as multimedia play or recordings play, and a receiver used only for receiving calls. According to an embodiment, the receiver and the speaker may be either integrally or separately implemented.

The display device 760 may be a device for visually presenting information to the user of the electronic device 701 and may include, for example, a display, a hologram device, or a projector and a control circuit for controlling a corresponding device. According to an embodiment, the display device 760 may include a touch circuitry or a pressure sensor for measuring an intensity of pressure on the touch.

The audio module 770 may convert a sound and an electrical signal in dual directions. According to an embodiment, the audio module 770 may obtain the sound through the input device 750 or may output the sound through an external electronic device (e.g., the electronic device 702 (e.g., a speaker or a headphone)) wired or wirelessly connected to the sound output device 755 or the electronic device 701.

The sensor module 776 may generate an electrical signal or a data value corresponding to an operating state (e.g., power or temperature) inside or an environmental state outside the electronic device 701. The sensor module 776 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 777 may support a designated protocol wired or wirelessly connected to the external electronic device (e.g., the electronic device 702). According to an embodiment, the interface 777 may include, for example, an HDMI (high-definition multimedia interface), a USB (universal serial bus) interface, an SD card interface, or an audio interface.

A connecting terminal 778 may include a connector that physically connects the electronic device 701 to the external electronic device (e.g., the electronic device 702), for example, an HDMI connector, a USB connector, an SD card connector, or an audio connector (e.g., a headphone connector).

The haptic module 779 may convert an electrical signal to a mechanical stimulation (e.g., vibration or movement) or an electrical stimulation perceived by the user through tactile or kinesthetic sensations. The haptic module 779 may include, for example, a motor, a piezoelectric element, or an electric stimulator.

The camera module 780 may shoot a still image or a video image. According to an embodiment, the camera module 780 may include, for example, at least one lens, an image sensor, an image signal processor, or a flash.

The power management module 788 may be a module for managing power supplied to the electronic device 701 and may serve as at least a part of a power management integrated circuit (PMIC).

The battery 789 may be a device for supplying power to at least one component of the electronic device 701 and may include, for example, a non-rechargeable (primary) battery, a rechargeable (secondary) battery, or a fuel cell.

The communication module 790 may establish a wired or wireless communication channel between the electronic device 701 and the external electronic device (e.g., the electronic device 702, the electronic device 704, or the server 708) and support communication execution through the established communication channel. The communication module 790 may include at least one communication processor operating independently from the processor 720 (e.g., the application processor) and supporting the wired communication or the wireless communication. According to an embodiment, the communication module 790 may include a wireless communication module 792 (e.g., a cellular communication module, a short-range wireless communication module, or a GNSS (global navigation satellite system) communication module) or a wired communication module 794 (e.g., an LAN (local area network) communication module or a power line communication module) and may communicate with the external electronic device using a corresponding communication module among them through the first network 798 (e.g., the short-range communication network such as a Bluetooth, a WiFi direct, or an IrDA (infrared data association)) or the second network 799 (e.g., the long-distance wireless communication network such as a cellular network, an internet, or a computer network (e.g., LAN or WAN)). The above-mentioned various communication modules 790 may be implemented into one chip or into separate chips, respectively.

According to an embodiment, the wireless communication module 792 may identify and authenticate the electronic device 701 using user information stored in the subscriber identification module 796 in the communication network.

The antenna module 797 may include one or more antennas to transmit or receive the signal or power to or from an external source. According to an embodiment, the communication module 790 (e.g., the wireless communication module 792) may transmit or receive the signal to or from the external electronic device through the antenna suitable for the communication method.

Some components among the components may be connected to each other through a communication method (e.g., a bus, a GPIO (general purpose input/output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 701 and the external electronic device 704 through the server 708 connected to the second network 799. Each of the electronic devices 702 and 704 may be the same or different types as or from the electronic device 701. According to an embodiment, all or some of the operations performed by the electronic device 701 may be performed by another electronic device or a plurality of external electronic devices. When the electronic device 701 performs some functions or services automatically or by request, the electronic device 701 may request the external electronic device to perform at least some of the functions related to the functions or services, in addition to or instead of performing the functions or services by itself. The external electronic device receiving the request may carry out the requested function or the additional function and transmit the result to the electronic device 701. The electronic device 701 may provide the requested functions or services based on the received result as is or after additionally processing the received result. To this end, for example, a cloud computing, distributed computing, or client-server computing technology may be used.

The electronic device according to various embodiments disclosed in the disclosure may be various types of devices. The electronic device may include, for example, at least one of a portable communication device (e.g., a smartphone), a computer device, a portable multimedia device, a mobile medical appliance, a camera, a wearable device, or a home appliance. The electronic device according to an embodiment of the disclosure should not be limited to the above-mentioned devices.

It should be understood that various embodiments of the disclosure and terms used in the embodiments do not intend to limit technologies disclosed in the disclosure to the particular forms disclosed herein; rather, the disclosure should be construed to cover various modifications, equivalents, and/or alternatives of embodiments of the disclosure. With regard to description of drawings, similar components may be assigned with similar reference numerals. As used herein, singular forms may include plural forms as well unless the context clearly indicates otherwise. In the disclosure disclosed herein, the expressions “A or B”, “at least one of A or/and B”, “A, B, or C” or “one or more of A, B, or/and C”, and the like used herein may include any and all combinations of one or more of the associated listed items. The expressions “a first”, “a second”, “the first”, or “the second”, used in herein, may refer to various components regardless of the order and/or the importance, but do not limit the corresponding components. The above expressions are used merely for the purpose of distinguishing a component from the other components. It should be understood that when a component (e.g., a first component) is referred to as being (operatively or communicatively) “connected,” or “coupled,” to another component (e.g., a second component), it may be directly connected or coupled directly to the other component or any other component (e.g., a third component) may be interposed between them.

The term “module” used herein may represent, for example, a unit including one or more combinations of hardware, software and firmware. The term “module” may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, the “module” may include an application-specific integrated circuit (ASIC).

Various embodiments of the disclosure may be implemented by software (e.g., the program 740) including an instruction stored in a machine-readable storage media (e.g., an internal memory 736 or an external memory 738) readable by a machine (e.g., a computer). The machine may be a device that calls the instruction from the machine-readable storage media and operates depending on the called instruction and may include the electronic device (e.g., the electronic device 701). When the instruction is executed by the processor (e.g., the processor 720), the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above sub-components may be omitted, or additional other sub-components may be further included. Alternatively or additionally, some components (e.g., the module or the program) may be integrated in one component and may perform the same or similar functions performed by each corresponding components prior to the integration. Operations performed by a module, a programming, or other components according to various embodiments of the disclosure may be executed sequentially, in parallel, repeatedly, or in a heuristic method. Also, at least some operations may be executed in different sequences, omitted, or other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

The embodiments disclosed herein are provided to easily describe technical details of the disclosure and to help the understanding of the disclosure, and are not intended to limit the scope of the disclosure. Therefore, it should be construed that all modifications and changes or various other embodiments based on the technical idea of the disclosure fall within the scope of the disclosure.

1. An electronic device for supporting a connected car service, the electronic device comprising:
at least one communication interface configured to perform communication with at least one of a vehicle or an external server;
a memory configured to store at least one first application program; and
a processor electrically connected with the at least one communication interface and the memory,
wherein the processor is configured to:
detect connection with the vehicle by using the at least one communication interface;
receive vehicle identification information from the vehicle;
receive display format information of the vehicle corresponding to the vehicle identification information from the external server by using the at least one communication interface;
determine a graphical user interface to be output through a display of the vehicle, based at least partly on the display format information; and
transmit data related to the determined graphical user interface to the vehicle by using the at least one communication interface such that the determined graphical user interface is output through the display of the vehicle.

2. The electronic device of claim 1, further comprising:
a display,
wherein the processor is configured to control the display to a black screen state, based at least partly on the connection with the vehicle.

3. The electronic device of claim 1, wherein the processor is configured to determine the external server to be accessed, based at least partly on the vehicle identification information.

4. The electronic device of claim 1, wherein the processor is configured to receive at least one of layout information, color information, resolution information, or image design information as at least part of an operation of receiving the display formant information of the vehicle from the external server.

5. The electronic device of claim 1, wherein the processor is configured to additionally receive, from the external server, information about at least one second application program executable through the vehicle.

6. The electronic device of claim 5, wherein the processor is configured to download, from a specified server, at least a part of the at least one second application program that is not included in the at least one first application program.

7. The electronic device of claim 1, wherein the processor is configured to map and store the vehicle identification information and the display format information of the vehicle.

8. An electronic device for supporting a connected car service, the electronic device comprising:
at least one communication interface configured to perform communication with at least one of a vehicle or an external server;
a memory configured to store at least one first application program; and
a processor electrically connected with the at least one communication interface and the memory,
wherein the processor is configured to:
detect connection with the vehicle by using the at least one communication interface;
receive vehicle identification information from the vehicle;
transmit the vehicle identification information to the external server by using the at least one communication interface;
receive, from the external server, data related to a graphical user interface corresponding to the vehicle identification information and to be output through a display of the vehicle; and
transmit, to the vehicle, the data related to the graphical user interface and received from the external server, by using the at least one communication interface such that the graphical user interface is output through the display of the vehicle.

9. A method for transmitting a graphical user interface determined based on vehicle identification information of an electronic device to a vehicle, the method comprising:
detecting connection with the vehicle by using at least one communication interface;
receiving the vehicle identification information from the vehicle;
receiving display format information of the vehicle corresponding to the vehicle identification information from an external server by using the at least one communication interface;
determining a graphical user interface to be output through a display of the vehicle, based at least partly on the display format information; and
transmitting data related to the determined graphical user interface to the vehicle by using the at least one communication interface.

10. The method of claim 9, further comprising:
controlling a display of the electronic device to a black screen state, based at least partly on the connection with the vehicle.

11. The method of claim 9, wherein the receiving of the vehicle identification information includes:
determining the external server to be accessed, based at least partly on the vehicle identification information.

12. The method of claim 9, wherein the receiving of the display format information of the vehicle includes:
receiving at least one of layout information, color information, resolution information, or image design information.

13. The method of claim 9, further comprising:
receiving, from the external server, information about at least one application program executable through the vehicle.

14. The method of claim 13, wherein the receiving of the information about the at least one application program includes:
downloading, from a specified server, at least a part of the at least one application program that the electronic device does not include.

15. The method of claim 9, wherein the receiving of the display format information of the vehicle includes:
mapping and storing the vehicle identification information and the display format information of the vehicle.
